(19) United States
(12) Patent Application Publication
(10) Pub. No.: US 2011/0168108 A1
(43) Pub. Date: Jul. 14, 2011

(54) Device for training or proving horses

(76) Inventor: Larry Lance Earl, Rockland, ID (US)

(21) Appl. No.: 12/930,356

(22) Filed: Jan. 3, 2011

Related U.S. Application Data
(60) Provisional application No. 61/335,337, filed on Jan. 6, 2010.

(51) Int. Cl. A01K 15/02

(52) U.S. Cl. 119/839

(57) ABSTRACT

A device for training or proving horses comprising a movable target which can be moved in multiple speeds and in multiple directions to simulate the natural movements of a live cow. Said target movements may be controlled by activating or creating programmed runs or by manual operation. System control and operation may be accomplished through a remote transmitter or other control interfaces.

### PRIORITY

This application claims priority to U.S. Provisional Patent 61/335,337, filed Jan. 6, 2010

### BACKGROUND

Historically, work completed on a cattle ranch required athletic and well trained horses. Training such horses requires large numbers of live cattle. Today, many of these ranch activities have become organized equine based competitive activities. In most cases, participants in these competitive events do not have access to sufficient live cattle to accomplish effective training.

### SUMMARY OF INVENTION

In the past, the training of cow horses occurred on cattle ranches where there were large numbers of cattle and ample opportunities to expose a horse to cattle and cattle work. Many of these ranching activities have been modified to be competitive events that are frequented by horse enthusiasts. Today, most horse owners do not have access to live cattle for training purposes. To correct this problem, mechanical devices have been manufactured which simulate the movement of live cattle. Even with the availability of these devices, most horse owners do not have the financial resources or the space required to own and operate a training device.

In competitive equine events, those few who have the ability to train a horse with a training device have a distinct and unfair advantage over the majority of horse owners. The present invention addresses this problem by making a state of the art training device available to all horse owners at a low cost.

According to an embodiment, the current invention is a device for training or proving horses comprising: a movable target; at least one interface configured to provide user control of the device; and, electronic components configured to control behavior of the movable target.

In one aspect, one or more programmed runs are configured to produce random movable target behavior while maintaining predictable target move characteristics as specified by established run parameters.

In one aspect, a user may create custom programmed runs through the independent configuration of run parameters.

In one aspect, programmed runs may be configured to control the movable target to simulate the actions of live cattle in known or established equine events, (for example: cutting classes offered by the National Cutting Horse Association or fence classes offered by the National Reined Cow Horse Association).

In one aspect, the current invention is coupled with a business method of judging and scoring a horse and rider in a competitive environment wherein the horse and rider perform by responding to movements of the movable target. The current invention is further coupled with a second business method wherein performance records may be recorded for purposes such as maintaining statistics, maintaining horse and rider standings, payment of prize money, and awarding prizes. The current invention is further coupled with a third business method wherein performance records for the horse and rider may be the basis for the creation of promotional materials for the marketing of the horse, and rider, or any combination of the horse and rider.

In one aspect, elements of random target behavior may be eliminated or modified by activating run modifiers.

In one aspect, a user interface may be used to interact with programmed runs to modify target behavior while the programmed run is in progress. Interfaces may include control panels, remote transmitters or any known method that may provide instructions to the device.

In one aspect, a user interface may be used to independently move the movable target in multiple directions and at a plurality of speeds. Interfaces may include control panels, remote transmitters or any known method that may provide instructions to the device.

In one aspect, vending method is provided to allow a user to activate the device for limited usage in exchange for a value received. The vending method may include any known vending method or device.

### BRIEF DESCRIPTION OF DRAWINGS

FIG. 1 shows one possible embodiment of the invention, comprising a drive unit, control panel movable target, drive line pulleys.

FIG. 2 shows one possible embodiment of a remote transmitter.

FIG. 3 is a flow chart that describes one possible method of a user purchasing and using the invention for a fixed period of time.

FIG. 4 shows one possible embodiment of the programming logic of a programmed run.

FIG. 5 illustrates one possible variation of a score card for judging a horse and rider's performance.

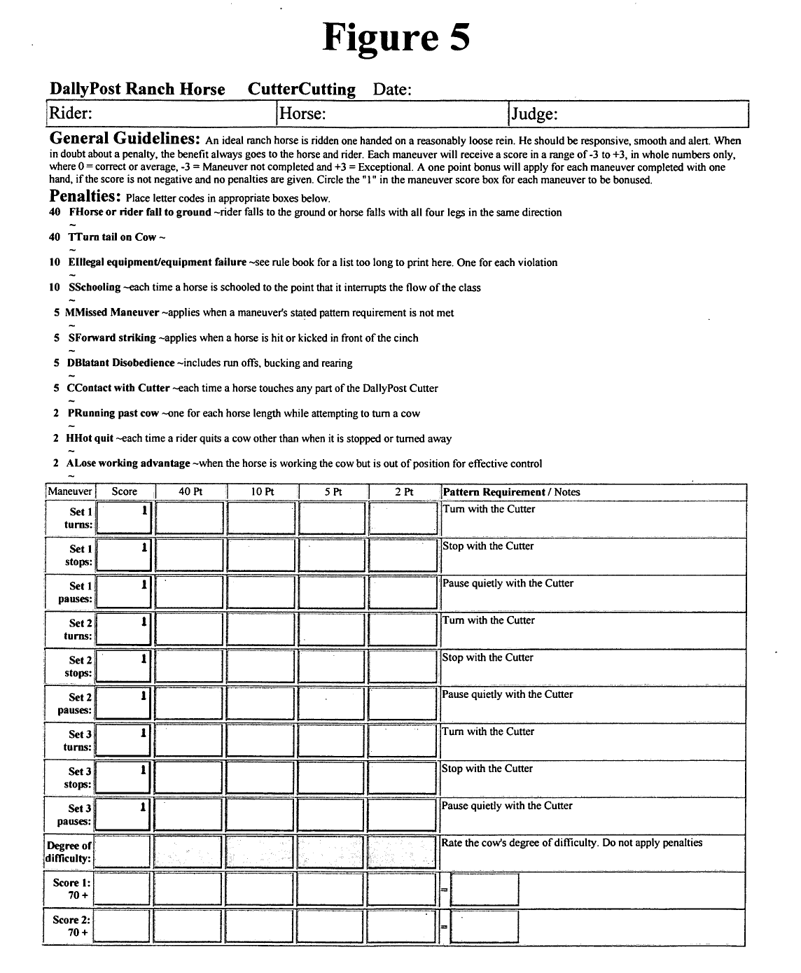

### DETAILED DESCRIPTION

In the following description, the use of “a”, “an”, or “the” can refer to the plural. All examples given are for clarification only, and are not intended to limit the scope of the invention.

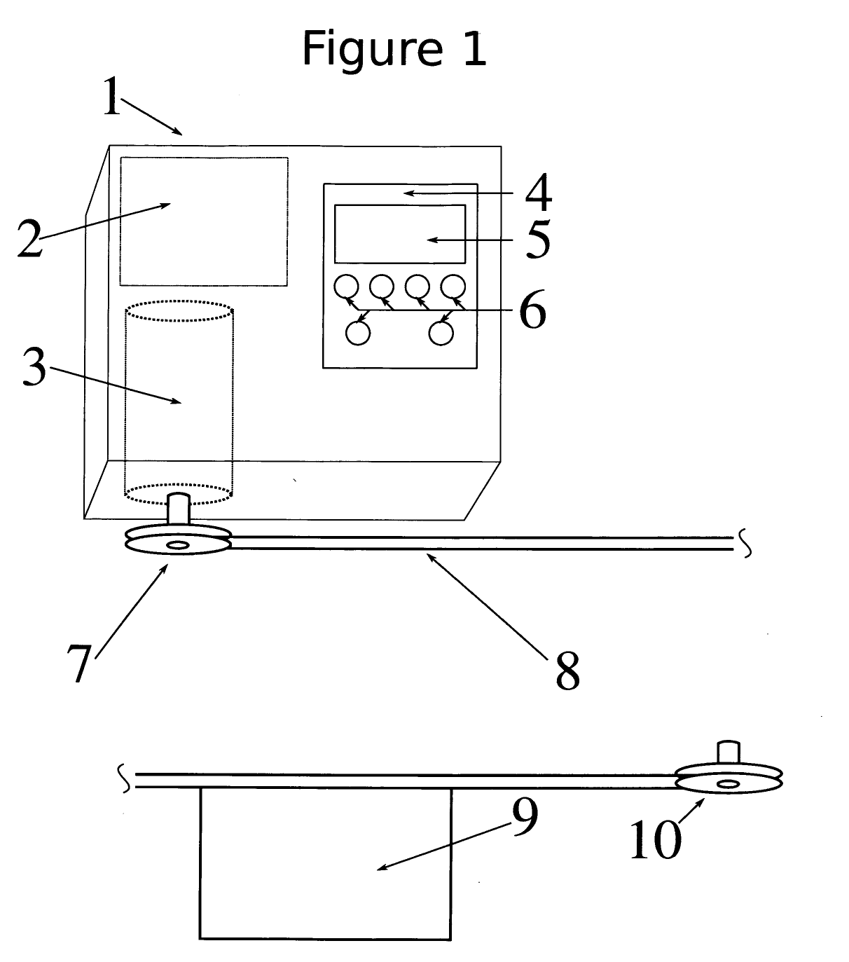

Referring to FIG. 1, according to an embodiment, the invention includes a system enclosure 1 that houses electrical and mechanical components comprising electrical circuitry 2 and a drive motor 3. A control panel 4 comprising a display 5 and control buttons 6 is integrated into the face of the enclosure 1. The drive motor shaft extends through the enclosure 1 and is attached to a drive pulley 7. When the drive pulley 7 is rotated by the drive motor 3, the drive line 8 moves around the idler pulley 10 and back toward the drive pulley 7. Movement of the drive line 8, creates a movement of the movable target 9. The drive pulley 7 may be rotated in a clockwise or counter clockwise direction. Rotation of the drive pulley 7 may be at one or more speeds.

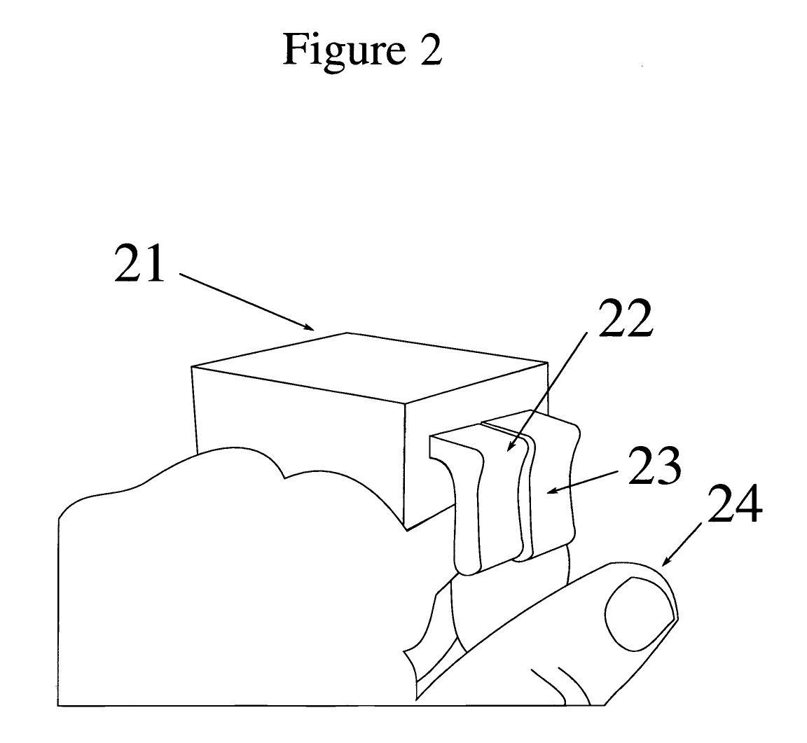

Referring to FIG. 2, according to an embodiment, shows a remote transmitter assembly. A transmitter enclosure 21 is attached to the back of the index and middle finger of a human hand 24. A left key 22 and right key 23 extend out of the enclosure and are configured to be pressed by the human thumb 24. This embodiment has been configured to allow the user to manipulate the left key 22 and the right key 23 without loosing the use and functionality of the hand 24, thereby allowing the user to manipulate the transmitter assembly while using the same hand to control a horse. The transmitter assembly will allow the user to control various functions of the invention.

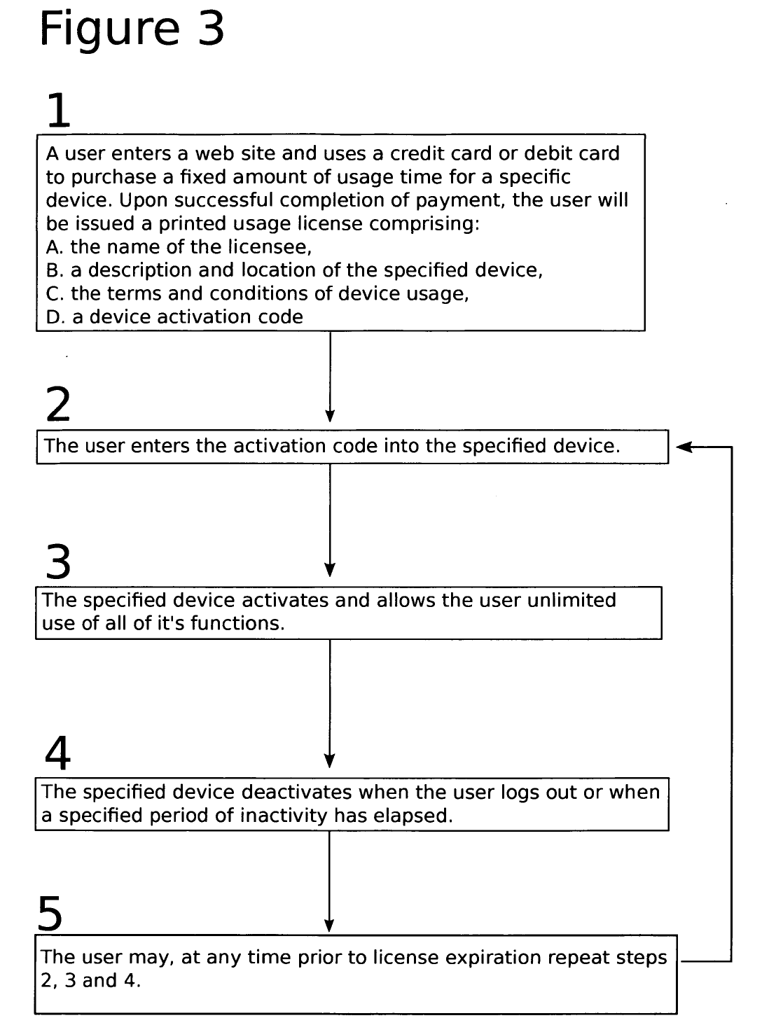

Referring to FIG. 3, according to an embodiment, shows a flow chart that illustrates how a user may purchase time to use the invention and how the user may activate and use the invention.

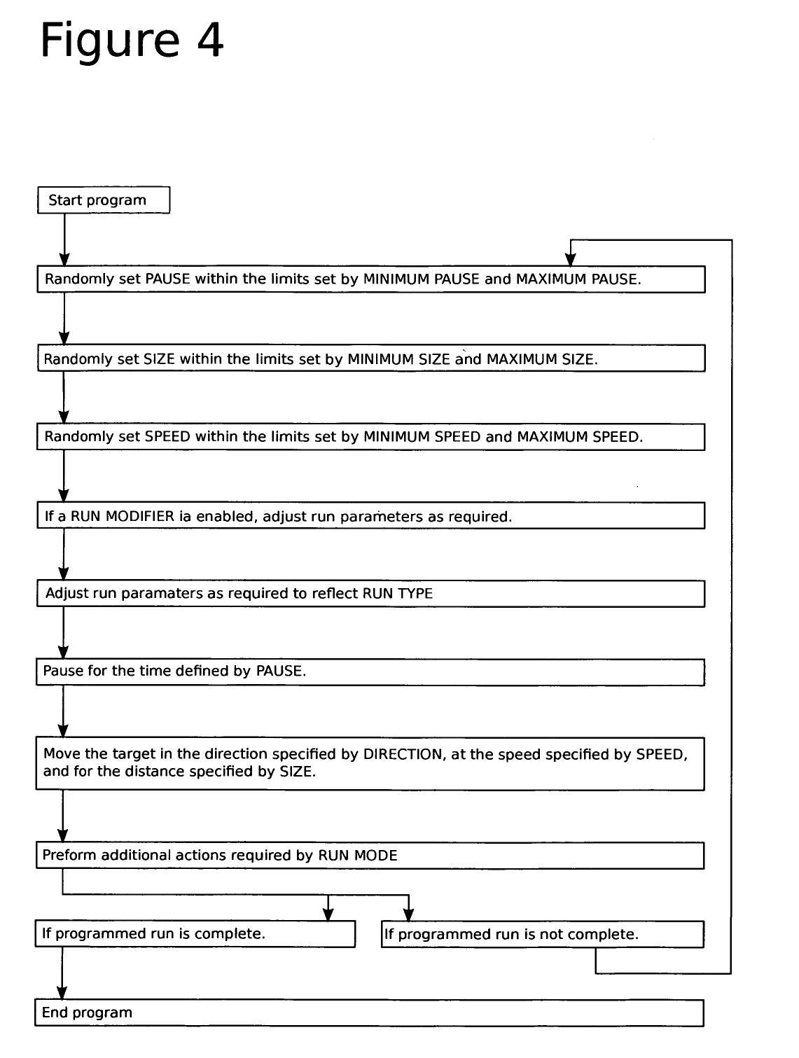

Referring to FIG. 4, according to an embodiment, shows a flow chart that illustrates the flow of a programmed run.

The invention, according to an embodiment includes one or more pre-programmed runs. Each pre-programmed run is governed by run parameters that control the minimum and maximum duration of the pre-move pause, the direction of the move, the minimum and maximum size of the move, and the minimum and maximum speed of a move. These run parameters are programmed into the system and may not be modified by the user.

The invention, according to an embodiment includes one or more user programmable custom runs. Each custom run is governed by run parameters that control the minimum and maximum duration of the pre-move pause, the direction of the move, the minimum and maximum size of the move and the minimum and maximum speed of a move. These run parameters are set by the user and may be modified at any time by the user.

Pre-programmed runs and custom runs may be modified by setting the Run Type to Cutting or Fence. When the Run Type is set to Cutting, the program will simulate a normal Cutting Class where the rider separates and works three separate cows. When Run Type is set to Fence, the program will simulate a normal fence class where the rider boxes a single cow and then turns it in both directions on the fence.

Because the invention, according to an embodiment, randomly selects pre-move pause times, move direction, move speed and move size, within the ranges established by run parameters, all runs will have an element of randomness that will simulate the randomness of working with live cattle. Furthermore, the combined run parameters define the difficulty level of a specific run. Therefore, runs may be configured to match a horse's abilities from basic to intermediate to advanced. When a run is repeated, using the same run parameters, the difficulty level will be maintained from one run to the next. However, the run pattern will have an element of randomness that will prevent consecutive runs from being identical. This will result in multiple runs where each run will have a unique run pattern, however, each consecutive run will maintain a consistent level of difficulty.

Though the invention, according to an embodiment, is configured to randomly set pre-move pause, move speed, move size and move direction in accordance with configured run parameters, a user may eliminate or modify one or more of the random elements of a run. For example, if the MINIMUM SPEED were stet to 2 and the MAXIMUM SPEED were set to 2, move speed will always be at speed 2. Speeds 1, 3 and 4 will not be used during the run.

Though the invention, according to an embodiment, is configured to randomly set pre-move pause, move speed, move size and move direction in accordance with configured run parameters, a user may eliminate or modify one or more of the random elements of a run by enabling one or more run modifiers.

Referring to FIG. 1, according to an embodiment, a program of showing horses as they react to movement of the target 9 will allow competitions to be held where the target 9 will be used in place of live cattle. Pre-programmed runs and custom runs may be configured by the user to simulate live cow competitions. This program includes a business method, comprising standardized competition rules; standardized score cards; a method of recording horse and rider performance; a method of retrieving horse and rider standings and statistics based on recorded performance data; a method of awarding prize money and awards based on recorded performance data; and, a method of producing marketing material for the promotion of the horse or rider based on recorded performance data. These standardized features will enable competitions to be held using the invention as a substitute for live cattle while maintaining standardized rules, judging and rules at all events.

Referring to FIG. 1 and FIG. 2: In this paragraph, left button shall refer to a button 6 labeled “Left” on the control panel 4 or the left transmitter key 22 on the remote transmitter 21. In this paragraph, right button shall refer to a button 6 labeled “Right” on the control panel 4 or the right transmitter key 23 on the remote transmitter 21. The invention, according to an embodiment includes a manual training option, wherein the user may use the left button or the right button to cause target 9 movement. The user may specify a minimum and maximum speed. When the left button is pressed and held, the target 9 will begin to move to the left at the set minimum speed. If the left button is quickly released and repressed, the target 9 will accelerate to the next available speed. Acceleration may be continued until the maximum speed had been reached. If the target 9 is moving at the maximum speed and the left button is quickly released and repressed, the target 9 will decelerate to the preceding speed. Target 9 movements to the right will be made in the exact same fashion except that the user will use the right button.

I claim:

1. A device for training or proving horses comprising: a movable target; at least one interface configured to provide user control of the said device; and, electronic components configured to control behavior of said movable target.

2. A device for training or proving horses as claimed in claim 1, wherein one or more programmed runs are configured to produce random said movable target behavior while maintaining predictable target move characteristics as specified by established run parameters.

3. A device for training or proving horses as claimed in claim 2, wherein a user may create custom said programmed runs through the independent configuration of said run parameters.

4. A device for training or proving horses as claimed in claim 3, wherein said programmed runs may be configured to control said movable target to simulate the actions of live cattle in established equine events, (for example: cutting classes offered by the National Cutting Horse Association or fence classes offered by the National Reined Cow Horse Association).

5. A device for training or proving horses as claimed in claim 4, further comprising a business method configured to judge and score a horse and rider in a competitive environment wherein said horse and said rider perform by responding to movements of the said movable target

6. A device for training or proving horses as claimed in claim 5, further comprising a business method wherein performance records for said horse and said rider may be recorded for purposes such as maintaining statistics, maintaining said horse and said rider standings, payment of prize money, and awarding of prizes.

7. A device for training or proving horses as claimed in claim 6, further comprising a business method wherein performance records for said horse and said rider may be the basis for the creation of promotional materials for the marketing of said horse, said rider, or any combination of said horse and said rider.

8. A device for training or proving horses as claimed in claim 4, wherein said target said random behavior may be eliminated or modified by activating run modifiers.

9. A device for training or proving horses as claimed in claim 4, wherein said user interface may be used to interact with said programmed runs to modify said target behavior while said programmed run is in progress.

10. A device for training or proving horses as claimed in claim 1, wherein said user interface may be used to move said movable target in multiple directions and at a plurality of speeds.

11. A device for training or proving horses as claimed in claim 1, wherein a vending method is provided to allow said user to activate said device for limited usage in exchange for a value received.

12. A device for training or proving horses comprising: a movable target; at least one interface configured to provide user control of said device; electronic components configured to control behavior of said movable target; and, a vending method to allow a user to activate said device for limited usage in exchange for a value received.

13. A device for training or proving horses as claimed in claim 12, wherein one or more programmed runs are configured to produce random said movable target behavior while maintaining predictable said target move characteristics as specified by established said run parameters.

14. A device for training or proving horses as claimed in claim 13, wherein said user may create custom programmed runs through the independent configuration of said run parameters.

15. A device for training or proving horses as claimed in claim 14, wherein said programmed runs may be configured to control said movable target to simulate the actions of live cattle in established equine events, (for example: cutting classes offered by the National Cutting Horse Association or fence classes offered by the National Reined Cow Horse Association).

16. A device for training or proving horses as claimed in claim 15, further comprising a business method wherein a horse and rider are judged and scored for their performance of responding to movements of the said movable target; and, further comprising a business method wherein performance records for said horse and said rider may be recorded for purposes such as maintaining statistics, maintaining said horse and said rider standings, payment of prize money, and awarding prizes; and, further comprising a business method wherein said performance records for said horse and said rider may be the basis for the creation of promotional materials for the marketing of said horse, said rider, or any combination of said horse and said rider.

17. A device for training or proving horses as claimed in claim 15, wherein aspects of said random said target behavior may be eliminated or modified by activating run modifiers.

18. A device for training or proving horses as claimed in claim 15, wherein said user interface may be used to interact with said programmed runs to modify said target behavior while said programmed run is in progress.

19. A device for training or proving horses as claimed in claim 12, wherein said user interface may be used to move said movable target in multiple directions and at a plurality speeds.
